(19) United States
(12) Patent Application Publication
(10) Pub. No.: US 2022/0262253 A1
(43) Pub. Date: Aug. 18, 2022

(54) PRIORITIZED LANE CHANGE WITH V2X ASSISTANCE

(71) Applicants: Zhibin WU, San Diego, CA (US); Hong CHENG, San Diego, CA (US); Dan VASSILOVSKI, San Diego, CA (US); Lan YU, San Diego, CA (US); QUALCOMM Incorporated, San Diego, CA (US)

(72) Inventors: Zhibin WU, Los Altos, CA (US); Hong CHENG, Basking Ridge, NJ (US); Dan VASSILOVSKI, Del Mar, CA (US); Lan YU, Beijing (CN)

(21) Appl. No.: 17/597,088

(22) PCT Filed: Jul. 22, 2019
(86) PCT No.: PCT/CN2019/097042

§ 371 Date: Dec. 23, 2021

(51) Int. Cl. G08G 1/16; H04W 4/024; H04W 4/029; H04W 4/46; H04B 7/06

(52) U.S. Cl. CPC G08G 1/167; G08G 1/161; G08G 1/166; H04B 7/0617; H04W 4/029; H04W 4/46; H04W 4/024

(57) ABSTRACT

A method, a computer-readable medium, and an apparatus are provided for wireless communication at a UE, e.g., associated with a host vehicle. The apparatus transmits a message comprising at least one of a lane change request or a lane space reservation and monitors for a response to the message. An apparatus at a first UE associated with a remote vehicle receives a message comprising at least one of a lane change request or a lane space reservation from a second UE. The apparatus determines whether to accept the lane change request or the lane space reservation from the second UE and transmits a response to the message accepting or rejecting the lane change request or the lane space reservation.

### CROSS REFERENCE TO RELATED APPLICATION(S)

This application is a National Stage Application filed under 35 U.S.C. § 371 of PCT International Patent Application Serial No. CT/CN2019/097042, entitled “PRIORITIZED LANE CHANGE WITH V2X ASSISTANCE” and filed on Jul. 22, 2019, which is expressly incorporated by reference herein in its entirety.

### BACKGROUND

### Technical Field

The present disclosure relates generally to communication systems, and more particularly, to vehicle-to-vehicle (V2V), vehicle-to-everything (V2X), or other device-to-device (D2D) communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. Aspects of wireless communication may comprise direct communication between devices, such as in V2X, V2V, and/or D2D communication. There exists a need for further improvements in V2X, V2V, and/or D2D technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE), e.g., associated with a host vehicle. The apparatus transmits a message comprising at least one of a lane change request or a lane space reservation and monitors for a response to the message.

In an aspect of the disclosure, a method, a computer-readable medium, and an apparatus are provided for wireless communication at a first UE associated with a remote vehicle. The apparatus receives a message comprising at least one of a lane change request or a lane space reservation from a second UE. The apparatus determines whether to accept the lane change request or the lane space reservation from the second UE and transmits a response to the message accepting or rejecting the lane change request or the lane space reservation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on V2V, V2X, and/or device-to-device communication.

FIGS. 4A and 4B illustrate examples of lane changes that may be coordinated based on aspects presented herein.

FIG. 5 illustrates an example of communication exchanged in connection with a lane change request.

FIG. 6 illustrates an example of communication exchanged in connection with a lane change request.

FIG. 7 illustrates an example of communication exchanged in connection with a lane change request.

FIG. 8 illustrates an example of communication exchanged in connection with a lane space reservation.

FIG. 9 illustrates an example communication flow between UEs.

FIG. 10 is a flowchart of a method of wireless communication.

FIG. 11 is a conceptual data flow diagram illustrating the data flow between different means/components in an example apparatus.

FIG. 12 is a diagram illustrating an example of a hardware implementation for an apparatus employing a processing system.

FIG. 13 is a flowchart of a method of wireless communication.

FIG. 14 is a conceptual data flow diagram illustrating the data flow between different means/components in an example apparatus.

FIG. 15 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

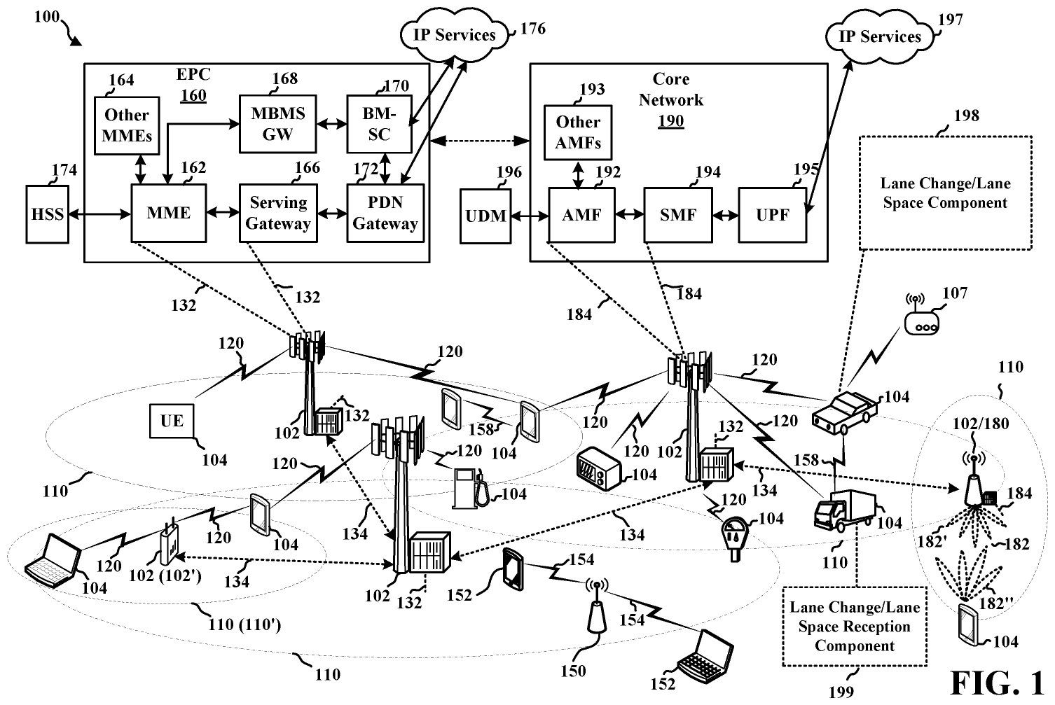

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and a Core Network (e.g., 5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., 51 interface). The base stations 102 configured for NR (collectively referred to as Next Generation RAN (NG-RAN)) may interface with Core Network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or Core Network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range.

Devices may use beamforming to transmit and receive communication. For example, FIG. 1 illustrates that a base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The Core Network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the Core Network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or Core Network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

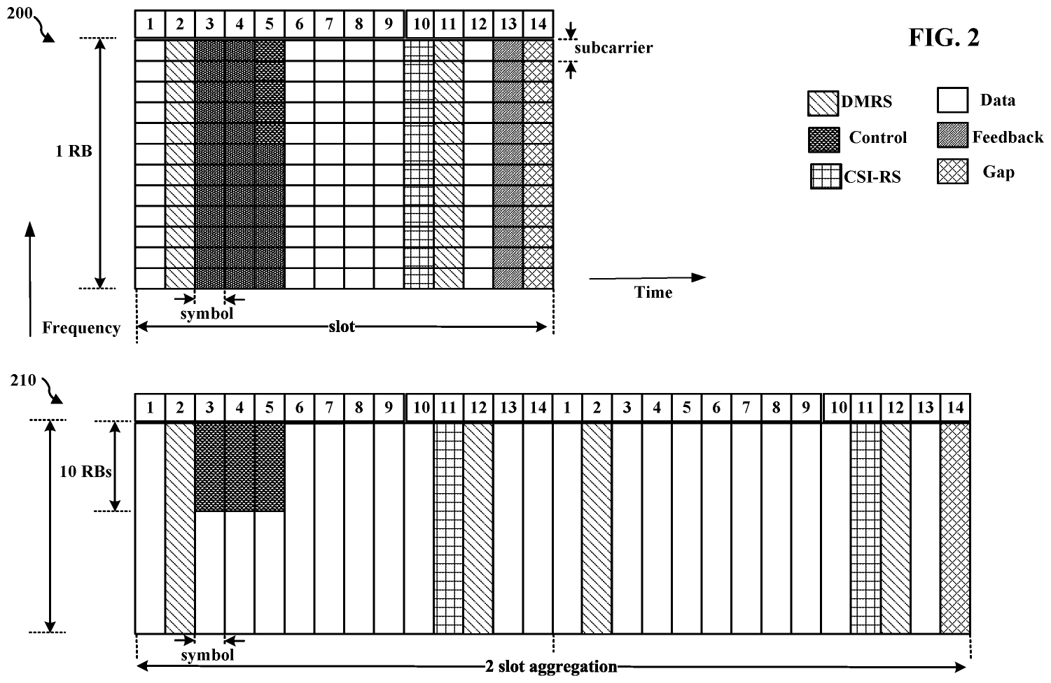

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2V/V2X/V2I or other D2D communication, such as Proximity Services (ProSe), etc. Communication based on V2V, V2X, V2I, and/or D2D may also be transmitted and received by other transmitting and receiving devices, such as Road Side Unit (RSU) 107, etc. Aspects of the communication may be based on PC5 or sidelink communication e.g., as described in connection with the example in FIG. 2. Although the following description may provide examples for V2X/D2D communication in connection with 5G NR, the concepts described herein may be applicable to other similar areas, such as LTE, LTE-A, CDMA, GSM, and other wireless technologies.

Referring again to FIG. 1, in certain aspects, the UE 104 may comprise a lane change/lane space component 198 configured to transmit a message comprising a lane change request and/or a lane space reservation and to monitor for a response to the message. For example, the UE 104 may monitor for a response to a lane change request from another UE 104, e.g., a remote vehicle (RV) or a target vehicle (TV), that accepts or rejects the lane change request. The UE 104 may then determine whether to proceed with the lane change and/or may adjust the lane change procedure based on the response from the other UE. In other aspects, a UE 104 may comprise lane change/lane space reception component 199 configured to receive the message comprising the lane change request and/or the lane space reservation from UE 104 and to determine whether to accept or reject the lane change request and/or the lane space reservation. The UE 104 may then transmit a response indicating the acceptance or rejection of the lane change request and/or the lane space reservation.

FIG. 2 illustrates example diagrams 200 and 210 illustrating examples slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single slot transmission, e.g., which may correspond to a 0.5 ms transmission time interval (TTI). Diagram 210 illustrates an example two-slot aggregation, e.g., an aggregation of two 0.5 ms TTIs. Diagram 200 illustrates a single RB, whereas diagram 210 illustrates N RBs. In diagram 210, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information, e.g., along with demodulation RS (DMRS). FIG. 2 also illustrates that symbol(s) may comprise CSI-RS. The symbols in FIG. 2 that are indicated for DMRS or CSI-RS indicate that the symbol comprises DMRS or CSI-RS REs. Such symbols may also comprise REs that include data. For example, if a number of ports for DMRS or CSI-RS is 1 and a comb-2 pattern is used for DMRS/CSI-RS, then half of the REs may comprise the RS and the other half of the REs may comprise data. A CSI-RS resource may start at any symbol of a slot, and may occupy 1, 2, or 4 symbols depending on a configured number of ports. CSI-RS can be periodic, semi-persistent, or aperiodic (e.g., based on DCI triggering). For time/frequency tracking, CSI-RS may be either periodic or aperiodic. CSI-RS may be transmitted in busts of two or four symbols that are spread across one or two slots. The control information may comprise Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 2. Multiple slots may be aggregated together. FIG. 2 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

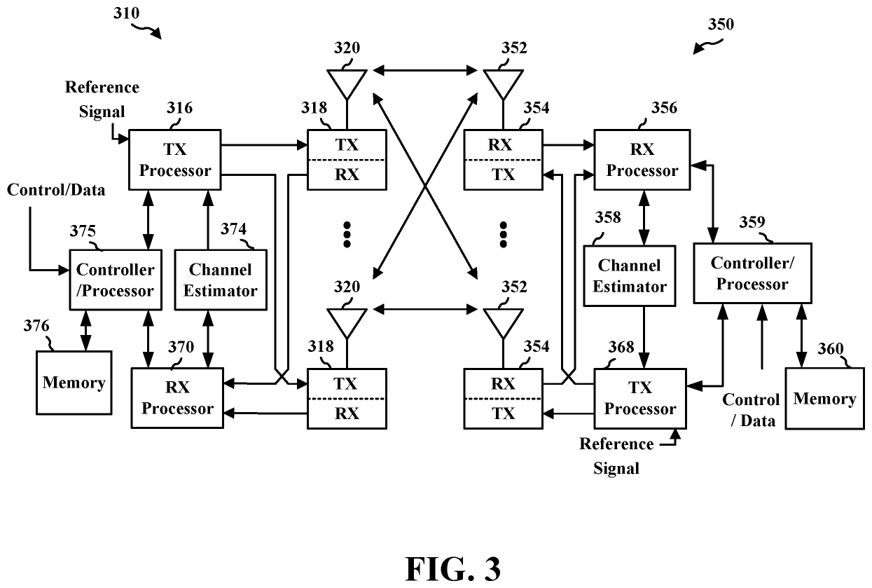

FIG. 3 is a block diagram 300 of a first wireless communication device 310 in communication with a second wireless communication device 350, e.g., via V2V/V2X/D2D communication. The device 310 may comprise a transmitting device communicating with a receiving device, e.g., device 350, via V2V/V2X/D2D communication. The communication may be based, e.g., on sidelink. The transmitting device 310 may comprise a UE, an RSU, etc. The receiving device may comprise a UE, an RSU, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, or the controller/processor 359 of device 350 or the TX 316, the RX processor 370, or the controller/processor 375 may be configured to perform aspects described in connection with 198 or 199 of FIG. 1.

V2X/V2V/D2D communication may be based on a slot structure comprising aspects described in connection with FIG. 2. For example, a transmitting UE may transmit a message, e.g., comprising a control channel and/or a corresponding data channel, that may be received directly by receiving UEs. A control channel may include information for decoding a data channel and may also be used by receiving device to avoid interference by refraining from transmitting on the occupied resources during a data transmission. The number of TTIs, as well as the RBs that will be occupied by the data transmission, may be indicated in a control message from the transmitting device. Each of the UEs may each be capable of operating as a transmitting device in addition to operating as a receiving device. The transmissions from a UE may be broadcast, multicast, groupcast, and/or unicast to nearby devices. For example, a UE may transmit communication intended for receipt by other UEs within a particular range of the UE.

Vehicles may initiate lane changes while driving. Lane changes may be based on different reasons. For example, traffic density is non-uniform. Thus, a lane change may be desirable to move from a high density lane to a lower density lane. As another example, a vehicle may need to perform a lane change in order to perform a maneuver such as exiting a highway or a freeway, in order to make a turn, in order to enter a parking lot, etc. Such lane changes may be referred to as a strategic lane change, e.g., for route purposes. As another example, a lane change may comprise a tactical lane change to increase speed, to pass a vehicle, etc. As another example, a corporative lane change may be performed in order to make room for inbound traffic from a ramp, in order to allow faster traffic to pass, etc. As another example, the lane change may be based on a road condition, e.g., a lane ending, a lane closure, an accident, a hazard in the lane, etc. As another example, the lane change may be triggered by an emergency situation. As one example, the lane change may be required by law, e.g., to move out of the way of emergency vehicles.

Coordination of lane changes, especially when multiple vehicles initiate lane changes, may help to improve safety. Aspects presented herein provide communication that assists with lane changes, whereas a basic safety message (BSM), cooperative awareness message (CAM), or decentralized environmental notification message (DENM) may broadcast basic information without coordination and without an ability to handle conflicts. Aspects presented herein provide a way to use communication directly between UEs, e.g., directly between vehicles, to coordinate lane change maneuvers among vehicles within proximity of each other. For example, V2X may be used to coordinate lane change maneuvers between vehicles. Unicast, groupcast, and/or broadcast may be used to coordinate lane change maneuvers. For example, vehicles may negotiate lane change maneuvers to reach a consensus in a distributed manner. Vehicles may exchange messages include a lane change request and/or a lane space reservation. The message(s) may include priority information, timer information, space information, etc.

Lane changes and space reservations may be treated as having different priorities or urgencies. For example a lane change/maneuver required by traffic law may be treated with a higher priority than a lane change/maneuver based on a road condition. A lane change/maneuver based on a road condition may have a higher priority than a strategic lane change/maneuver, e.g., for route purposes. A strategic lane change may have a higher priority than a corporative lane change (to make room for traffic from a ramp, etc.). A corporative lane change may have a higher priority than a tactical lane change or an opportunistic lane change, e.g., to increase speed or pass a slower vehicle. The following illustrates an example relationship of priority among the different lane changes/space requirements:

Traffic Law Requirement>Road Condition>Strategic>Corporative>tactical/opportunistic

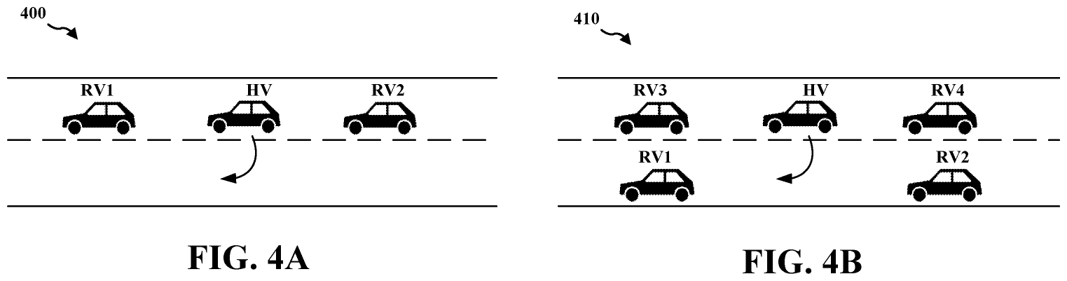

FIGS. 4A and 4B illustrate examples 400, 410 of potential lane changes. A host vehicle (HV) may be a vehicle initiating the lane change. The host vehicle may need to coordinate with other remote vehicles (RVs), e.g., other vehicles in the proximity of the HV. In some examples, an RV may be referred to as a target vehicle (TV). A TV may also be used to refer to a vehicle to which the HV directs a message or that may be involved/affected by a planned vehicle maneuver. In FIG. 4A, the host HV may initiate a lane change from a high density lane to a lower density lane. In FIG. 4A, there is a sufficient gap between vehicles in the desired lane to accommodate the lane change by the HV. However, as shown in FIG. 4B, when vehicle density is higher in the lane to which the HV will change, coordination among the vehicles may be beneficial. Coordination may also be helpful in the example in FIG. 4A, e.g., if one of the RVs (RV1 or RV2) also plans to initiate a lane change. The HV may communicate in various ways to coordinate the lane with the other vehicles. For example, the HV may send a message to at least one RV requesting cooperation with the HV's lane change. The HV may send a message to at least one RV requesting space coordination and speed adjustment to enable the HV to move into the new lane smoothly. In the example in FIG. 4B, for example, the HV may exchange messages with RV1 and RV2 to ensure that enough space is created in the new lane to accommodate the HV's move to the new lane. The HV may exchange messages with RV3 and RV4 to maintain enough space between vehicles to allow the HV to adjust its speed before merging between RV1 and RV2 in the new lane.

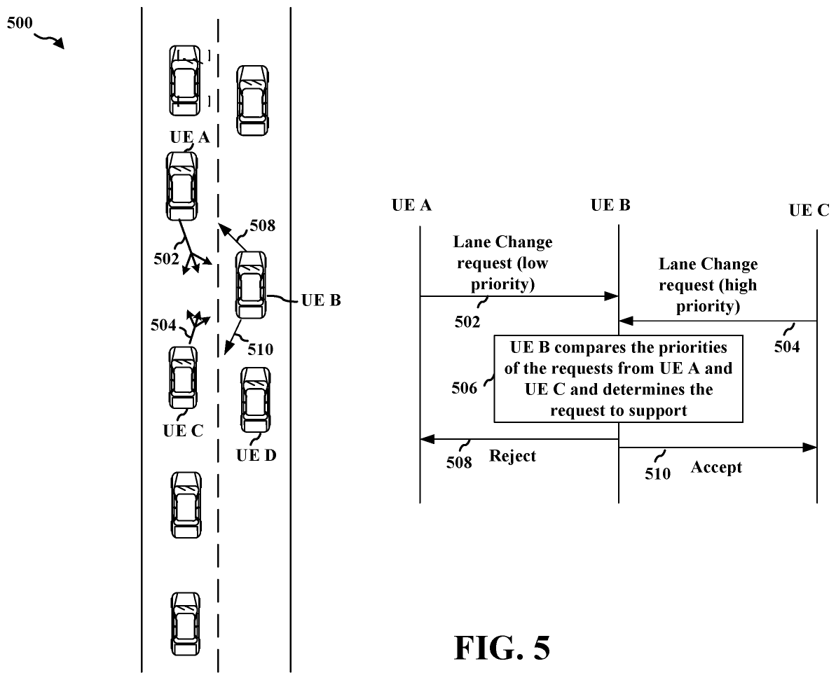

In certain aspects, conflict resolution may be used to coordinate different lane change requests that involve conflicting maneuvers by the involved vehicles. A vehicle may have limited room to perform a maneuver to accommodate lane change requests by adjacent vehicles. FIG. 5 illustrates an example 500 of a lane change conflict. In FIG. 5, a first UE (e.g., UE A associated with a first vehicle) sends a lane change request 502 that is received by a second UE (e.g., UE B associated with a second vehicle). The lane change request 502 may be unicast to UE B. In another example, the lane change request may be broadcast, multicast, or groupcast and received by UE B. A third UE (e.g., UE C associated with a third vehicle) may also send a message comprising a lane change request 504. Similar to the lane change request 502, the lane change request 504 may be unicast, groupcast, multicast, or broadcast. If UE B allows UE A to move into the lane in front of UE B, then UE B may need to decelerate to make additional space to UE A. However, the deceleration may potentially reduce the space that is available for UE C to change lanes into a space behind UE B. Likewise, if UE B allows UE C to change lanes into a space behind UE B, then UE B may need to accelerate to increase the distance between UE B and UE C. However, the acceleration may potentially reduce the available space for UE A to move into the lane. Therefore, there may be a conflict between the two lane change requests. Thus, UE B may identify whether a conflict exists between a particular lane change request and a planned maneuver by another vehicle or by itself. When a conflict exists, UE B may determine which request to accept, e.g., at 506. For example, each request may have a priority level. UE B may compare the priority levels and determine to accept the higher priority request. In FIG. 5, the request 502 from UE A may have a lower priority level than the request from UE C. Therefore, UE B may respond by sending a rejection 508 of the request to UE A. UE B may respond to the request from UE C by sending an acceptance 510 of the request. The rejection message 508 may be unicast from UE B to UE A. The acceptance message 510 may be unicast from UE B to UE C. Thus, the detection of a conflict may lead UE B to transmit unicast signaling with the respective UEs to coordinate vehicle maneuvers.

A lane change request message may comprise an indication of a priority level and/or a reason for the lane change. The lane change request message may comprise an indication of the lanes involved in the change, e.g., a source location of the UE prior to the lane change and/or a destination location of the UE after the requested lane change. The lane change request message may comprise an indication of a timeline associated with the lane change, e.g., a planned start time and/or a planned ending time for the lane change maneuver, etc. The lane change request message may comprise an indication of a target lane space reservation to accommodate the lane change. The lane change request message may comprise an indication of suggested movement(s) for surrounding vehicle(s) that may be affected by the lane change. For example, UE A in FIG. 5 may suggest that UE B adjust its speed to accommodate the requested lane change by UE A. If the lane change request message disputes another lane change request and/or space reservation request/announcement by another vehicle, the lane change request message may include information about the disputed lane change request/space reservation. For example, the lane change request may comprise an ID or other information associated with the disputed message. The lane change request may indicate an amount of time, e.g., a time window, during which the UE sending the lane change request will monitor for a response from other vehicles.

The lane change request may be transmitted as a broadcast/announcement message, e.g., if there is no specific vehicle that is a target vehicle for coordination. Such a broadcast lane change request may include an indication of any of a priority level, a reason, lanes involved in the request, a timeline, a target space reservation, etc. In other examples, the lane change request may be a unicast message directed to a specific UE. A unicast lane change request may include information similar to the broadcast example, and may further include a suggested movement for a target vehicle and/or may identify a disputed request/maneuver requested by another vehicle.

The rejection message, e.g., rejection 508, may indicate a reason for the rejection. For example, a rejection message may include a rejection code. The rejection message may include additional information. As an example of additional information, an indication may be provided about non-V2X vehicles or road obstacles that are detected by the UE rejecting the request. For example, a perceived object container may be included in the rejection message enabling the UE to provide a description of non-V2X vehicle(s), road conditions, obstacles, etc.

The acceptance message, e.g., acceptance 510, may provide information beyond the acceptance of the requested lane change/space reservation. As an example, the acceptance message may comprise information about the UE's planned maneuver to accommodate the lane change request. For example, acceptance 510 from UE B may indicate that UE B intends to increase speed to accommodate the lane change request from UE C.

UEs may transmit messages comprising a lane space reservation information. The lane space reservation may be associated with a planned lane change, e.g., to assist with the needed maneuvers for the completion of a lane change. For example, UE B and/or UE C may transmit a message comprising a lane space reservation to help ensure that UE C has enough space to perform the lane change. As an example, if UE B increases speed in an attempt to increase the distance between UE B and UE D in order to assist UE C in making the requested lane change, the increase in UE B's speed may trigger UE D to increase its speed. Not only would an increase in UE D's speed avoid an increase in the space between UE B and UE D, but it may also cause UE D to be in a position that prevents UE C from performing the lane change. By sending a lane space reservation, UE D and other nearby UEs may allow UE B to make room for UE C by avoiding use of the reserved space. A lane space reservation may be used to change position for a lane change or other maneuver. The lane space reservation message may enable the UE to declare in advance a need/request for a particular gap in front of or behind a vehicle to provide protection for a short term movement.

A space reservation (e.g., a lane space reservation) may apply for a limited time. The amount of time may be indicated in the message. A space reservation may indicate the reserved space in any of various ways. As an example, the space reservation may indicate the reserved space using geographic coordinates. A UE may indicate a time series of vehicle locations representing the trajectory of the movement. The UE may indication a geographic location and a speed of the vehicle. In another example, the receiving UE may derive a safe distance based on a location/speed of the vehicle transmitting the space reservation. In another example, the UE requesting the space reservation may indicate a forbidden region using absolute geographic coordinates. The reserved space may be indicated based on an indicated gap. For example, the UE may indicate for other vehicle(s) to maintain a distance L of (L₁, L₂, . . . , Lᵢ) from the vehicle at times t (t₁, t₂, . . . , tᵢ). The receiving vehicle may use a knowledge of the location of the UE that is requesting the reserved space along with the indicated distance(s) to determine the reserved space. The reserved space may be indicated based on a change in speed that is requested/expected by a vehicle in order to maintain the reserved space. For example, UE B may indicate a deceleration to UE D in order to maintain/create a reserved space to accommodate a lane change by UE C. In other examples, an acceleration may be indicated, e.g., to a vehicle in front of UE B. As well, UE B might indicate for UE D to maintain its speed while UE B accelerates in order to maintain the reserved space.

Similar to a lane change request, a space reservation may include an indication of a priority level associated with the space reservation and/or a reason for the space reservation. The space reservation may indicate an amount of time, e.g., a time window, during which the UE sending the space reservation will monitor for a response from other vehicles. For example, a timer may allow an amount of time for other vehicles to respond.

A space reservation message may be broadcast so that it can be received by all UEs within the proximity of the UE sending the message. A space reservation message may be groupcast, e.g., so that it can be received by certain UEs within the proximity of the UE sending the message. In another example, a space reservation message may be unicast and directed to a particular UE. For example, UE B might send a unicast space reservation message to UE D in order to accommodate the lane change request by UE C. Multiple lane space reservation messages may be sent using unicast to relevant vehicles, e.g., in a one-by-one manner with each unicast message being sent to a different vehicle that may be affected by the space reservation.

A space reservation message may be a request, e.g., a negotiable space reservation. In another example, a space reservation message may be an announcement, e.g., a non-negotiable space reservation. A non-negotiable space reservation message may be transmitted when a lane change maneuver is actually started by a vehicle. The non-negotiable space reservation message may provide a warning to nearby vehicles so that they do not invade a safe space reserved for the vehicle that is in the process of changing lanes.

A negotiable space reservation message may be used to request or indicate an intention to use a space in the future. A negotiable message may include the priority level or reason for the space reservation. A UE sending a negotiable space reservation message may monitor for a response following the message to determine whether there are any challenges/disputes from other vehicles about the reserved space. Other vehicles may determine whether to agree to the space reservation. For example, an affected vehicle may determine whether to agree to the space reservation message based on the priority level and/or reason associated with the space reservation. The UE sending a negotiable space reservation message may determine to proceed with the intended maneuver, e.g., if no challenge/dispute/rejection is received within a time window.

A space reservation message may be sent, for example, by a vehicle that does not change a lane. The space reservation message may be used to reserve space for to accommodate a maneuver by a different vehicle, another vehicle that will be changing lanes. For example, UE B in FIG. 5, which does not intend to change lanes, may send a space reservation message to accommodate a lane change by UE A or UE C. A space reservation message may also be used in scenarios other than a lane change. For example, a space reservation message may be used for coordinated driving among multiple vehicles, platooning, etc. A lane change message may be sent by a vehicle that is actually intending to perform the lane change. A lane change message may include a space reservation, e.g., an information element for a space reservation, in a target lane for which the UE is requesting the lane change.

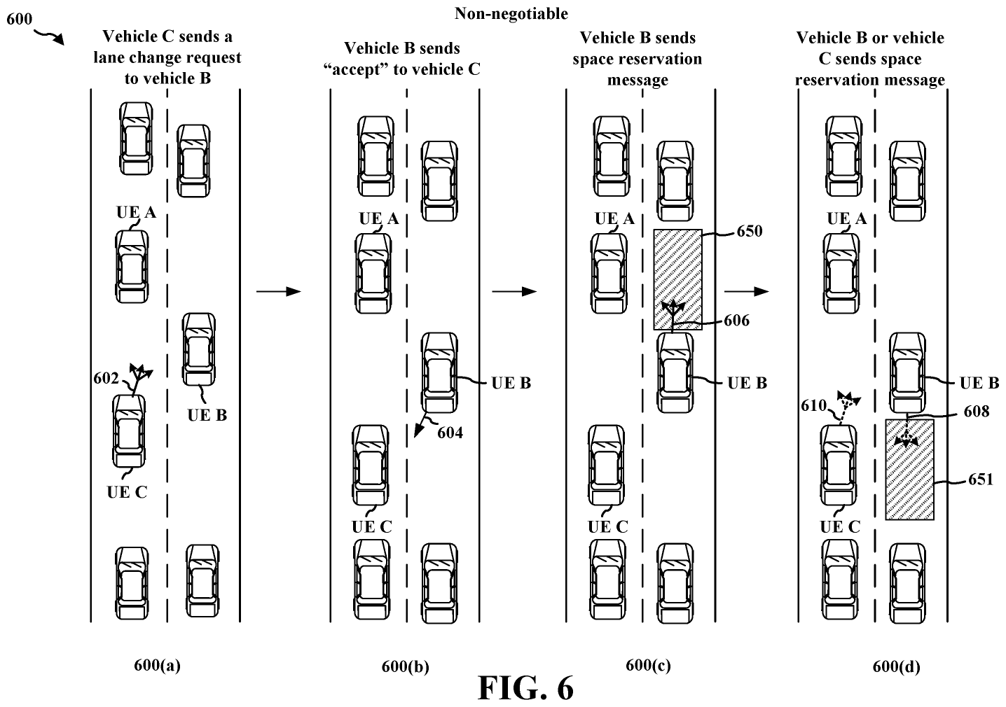

FIG. 6 illustrates an example 600 of a non-negotiable space reservation message exchange between vehicles. At a first point in time 600(a), UE C sends a lane change request 602. The lane change request 602 may be broadcast, groupcast, etc. The lane change request 602 may be unicast to UE B. At time 600(b), UE B may send a response 604 to UE C accepting the lane change request. The response 604 may be unicast directly to UE C, for example. UE B may also send a space reservation message 606 to ensure that there is enough room for UE B to accelerate to accommodate the lane change by UE C. The space reservation message may warn UE A, as well as other UEs, not to change lanes or to otherwise enter the space 650 being reserved by UE B. The space reservation message 606 may be broadcast or groupcast so that it can be received by nearby UEs. The space reservation message 606 may be unicast to UE A, etc. UE B and/or UE C may send a space reservation message to reserve space 651 behind UEB for the lane change by UE C. FIG. 6 illustrates an example space reservation message 608 from UE B and an example space reservation message 610 from UE C. The space reservation message 608, 610 may help to ensure that vehicles behind UE B do not close the distance to UE B and/or change lanes into the space being reserved to accommodate the lane change by UE C. Although FIG. 6 illustrates the space reservation messages 606, 608, 610 at 600(c) and 600(d), the messages may be sent at the same time. FIG. 6 illustrates an example of a non-negotiable space reservation message that is announced by UE B or UE C.

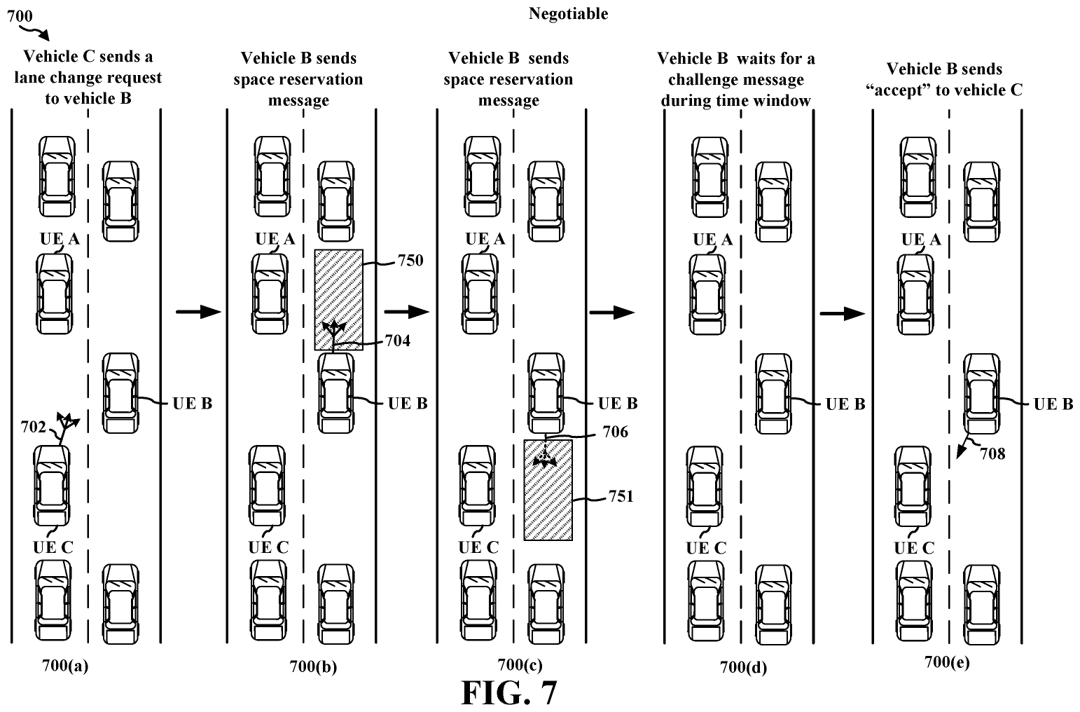

FIG. 7 illustrates an example 700 of a negotiable space reservation message. At 700(a), UE C sends a lane change request message 702 that is received by UE B, as described in connection with the example in FIG. 6. At 700(b), UE B sends a space reservation message 704 to reserve space 750, and at 700(c), UE B sends a space reservation message 706 to reserve space 751. Although illustrated separately at 700(b) and 700(c), space reservation messages 704, 706 may be sent at the same time and/or may be sent in the same message. Space reservation messages 704, 706 may be similar to space reservation messages 606, 608. However, space reservation messages 704, 706 may be negotiable messages that are sent to check with nearby vehicles to determine whether the space 750, 751 can be reserved without dispute. For example, space reservation message 704 may be sent to check with UE A to see whether UE A will dispute the reservation of space 750. Space reservation message 706 may be sent to see whether vehicle(s) behind UE B will dispute the reservation of space 751 to enable UE C to change lanes.

As illustrated at 700(d), UE B may wait for an amount of time to see whether any responses are received that dispute, challenge, or otherwise reject the space reservation message(s) 704, 706. UE B may monitor for response(s) during a particular window of time following the corresponding space reservation message. The window of time may be indicated in the space reservation message or may be based on a predefined amount of time. As illustrated at 700(e), UE B may send an accept message 708 to UE C indicating that UE B accepts the lane change request from UE C. UE B may send the accept message to UE C, if no responses are received to the space reservation messages 704, 706 disputing or rejecting the reservation of space 750, 751. If UE B does receive a response disputing or otherwise rejecting the reservation of space 750 or 751, UE B may instead send a rejection message to UE C in response to the lane change request. The rejection message may indicate a reason for the rejection, e.g., the dispute of a space reservation needed for the lane change. The acceptance 708, or a rejection, may be sent via unicast between UE B and UE C. The space reservation messages 704, 706 are negotiable because UE B monitors for a response from nearby UEs before taking action, e.g., before accepting the lane change request from UE C.

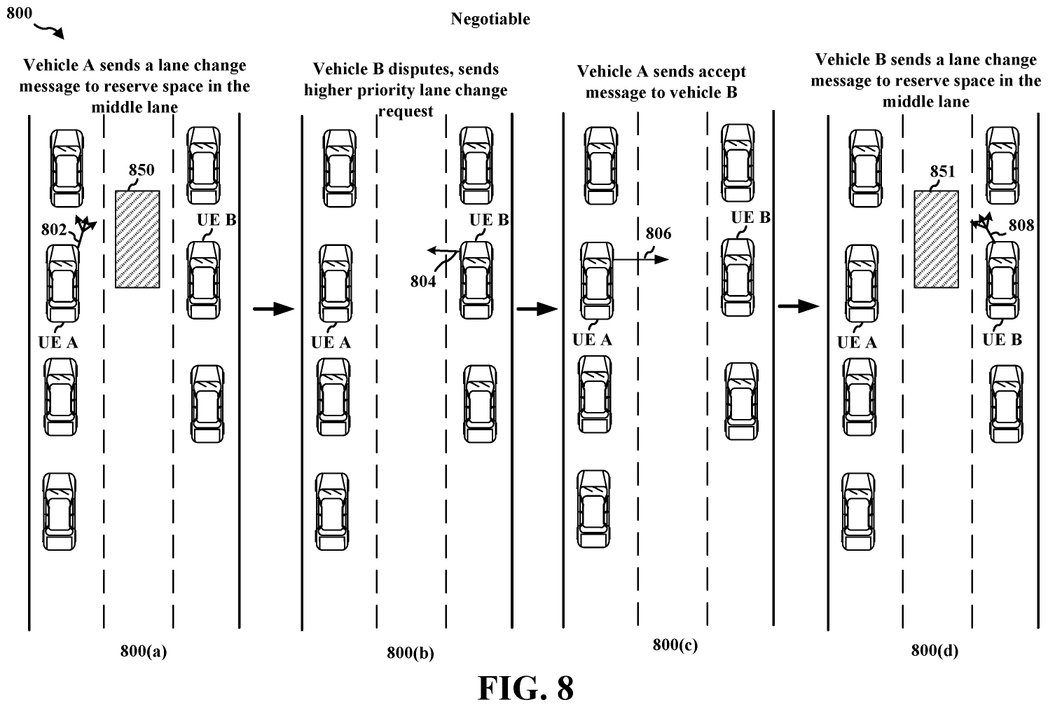

FIG. 8 illustrates another example 800 in which a vehicle may send a space reservation message for its own purpose, e.g., without being triggered by a lane change or other request from another vehicle. As illustrated at 800(a), UE A sends a lane change request message 802 to change lanes to the middle lane. The lane change request 802 may include a lane space reservation to reserve space 850 in the middle lane. At 800(b), UE B may dispute the lane change request and/or the lane space reservation in response 804. The response 804 may include a lane change request and/or lane space reservation from UE B having a higher priority level than the lane change request/lane space reservation from UE A. At 800(c), UE A may send a message to UE B accepting the lane change request/lane space reservation of UE B or otherwise indicating that UE A yields to UE B's request. UE A may accept UE B's lane change request/lane space reservation due to the higher priority level. At 800(d), UE B may send a lane space reservation message 808, e.g., which may comprise a lane change request or other lane change reservation, to reserve space 851 in the middle lane. In one example, the lane change request/lane reservation request 802, 808 may be broadcast or groupcast, whereas the exchange of messages 804, 806 between UE A and UE B may be unicast.

In other examples, a lane change request/lane space reservation may be sent in unicast to a single target vehicle. For some lane changes, a host vehicle may need to send lane change requests/lane space reservations to more than one target vehicle in order to coordinate with multiple surrounding vehicles that may be affected by the lane change.

A lane change request and/or a lane space reservation message may have an expiration time or a time window for a response. After the expiration time, the lane change request or lane space reservation may be disregarded, for example. As another example, a host vehicle may send a lane change cancelation message indicating that the UE cancels or revokes the previous lane change request. For example, the change may be due to a change in road conditions, a change in a condition that triggered the lane change request, etc. The host vehicle may indicate the reason for the cancelation of the lane change request.

Lane space reservation messages and/or lane change requests may be sent in different directions, e.g., using different beams. For example, different lane space reservation messages having different content may be sent in different directions using different beams. As an example, UE B in FIG. 7 may transmit space reservation message 704 to reserve space in front of the vehicle in a direction toward the front of the vehicle, e.g. using at least a first beam. UE B may transmit space reservation message 706 to reserve space behind the vehicle in the direction toward the rear of the vehicle, e.g., using at least a second beam. Thus, the UE may transmit a space reservation message using a beam that is in a direction of the reserved space.

A lane change request and/or lane space reservation message may comprise information that is included in other types of messages and/or may be combined with other announcements/messages. For example, a lane change request and/or lane space reservation message may comprise contents of a BSM, CAM, and/or DENM. A lane change request and/or lane space reservation message may be combined with a BSM, CAM, and/or DENM. For example, the lane change request and/or lane space reservation message may include information that describes a current state of the vehicle.

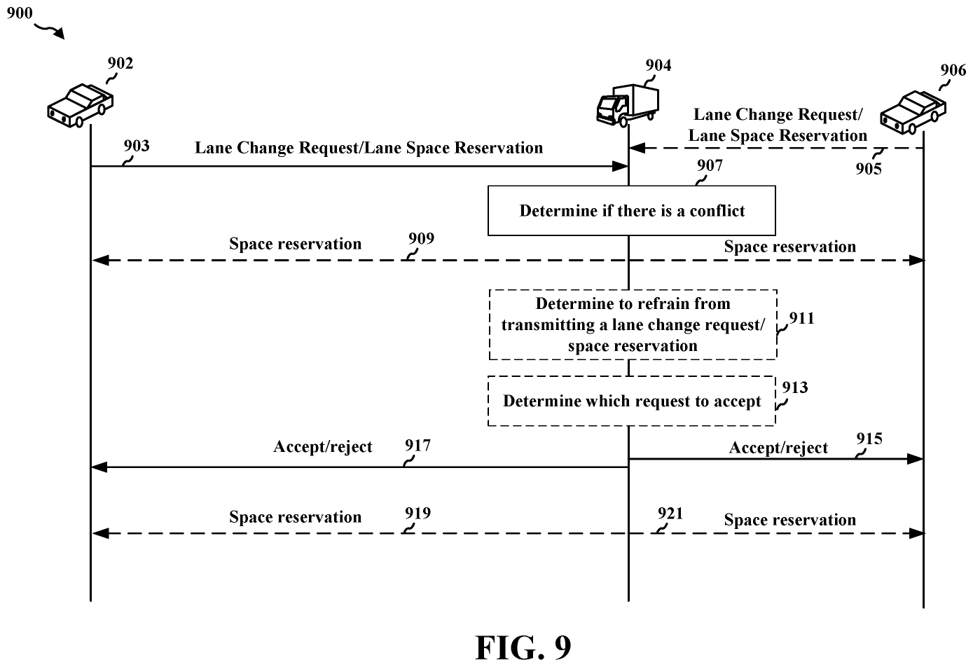

FIG. 9 illustrates an example communication flow 900 between UEs to coordinate lane changes or other vehicle maneuvers. The communication between the UEs may be based on V2X/V2V/D2D communication. FIG. 9 illustrates that a first UE 902 may transmit a lane change request and/or a lane space reservation message 903 that is received by another UE 904. The message may be a broadcast that is received by UE 904 or may be a unicast directed to UE 904. UE 904 may determine, at 907, whether there is a conflict with the request from UE 902. Based on the determination, UE 904 may respond with an acceptance or a rejection, at 917. As one example, UE 904 may transmit a space reservation message 909, which may be broadcast/groupcast or may be unicast to individual UEs, and may determine whether there the space may be reserved without dispute as part of the determination at 907. In another example, the UE 904 may determine whether a conflicting lane change request or lane space reservation has been received from another UE. For example, if UE 904 has received a conflicting lane change request or lane space reservation 905 from another UE 906. If there are conflicting lane change requests, for example, UE 904 may determine at 913 which request to accept. The determination may be based, e.g., on a comparison of a priority level or a reason for the respective requests. Then, at 915 and 917, UE 904 may accept one request and rejection the other, based on the determination at 913. As another example, at 911, the UE 904 may refrain from transmitting its own lane change request or lane space reservation based on receiving a higher priority lane change request from UE 902 and/or UE 906. As described in connection with FIG. 6, UE 904 may transmit space reservation(s) 919, 921 after accepting a lane change request from one of UEs 902, 906. In one example, space reservations 919, 921 may be non-negotiable, whereas space reservation 909 may have been a negotiable space reservation.

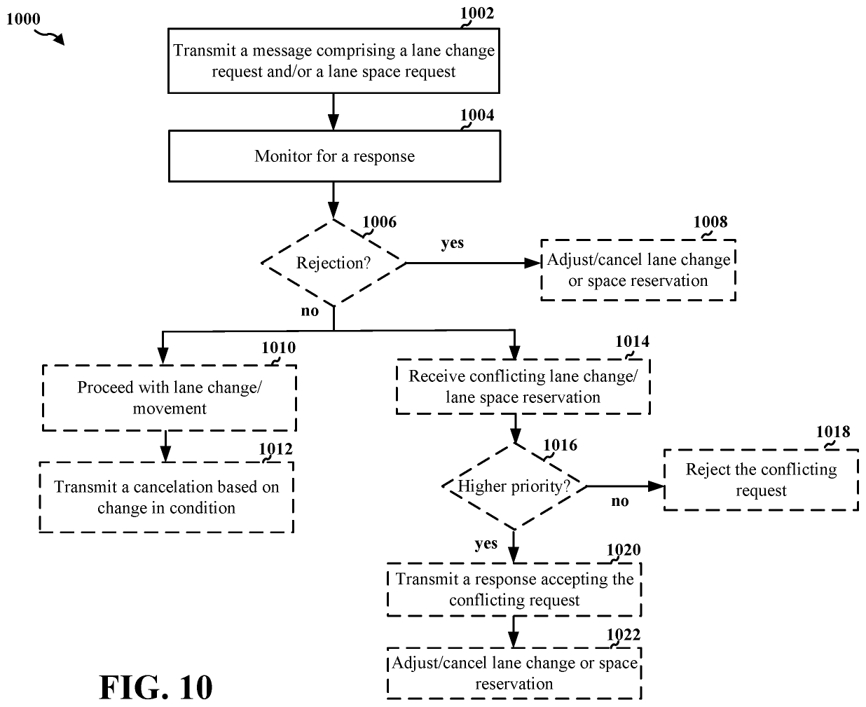

FIG. 10 is a flowchart 1000 of a method of wireless communication. The method may be performed by a UE or a component of a UE (e.g., the UE 104, 310, 902, 906, 1450; the apparatus 1102/1102′; the processing system 1214, which may include memory and which may be an entire UE or a component of a UE). Optional aspects are illustrated with a dashed line. The method may allow a UE to coordinate a lane change maneuver between multiple vehicles in a distributed manner.

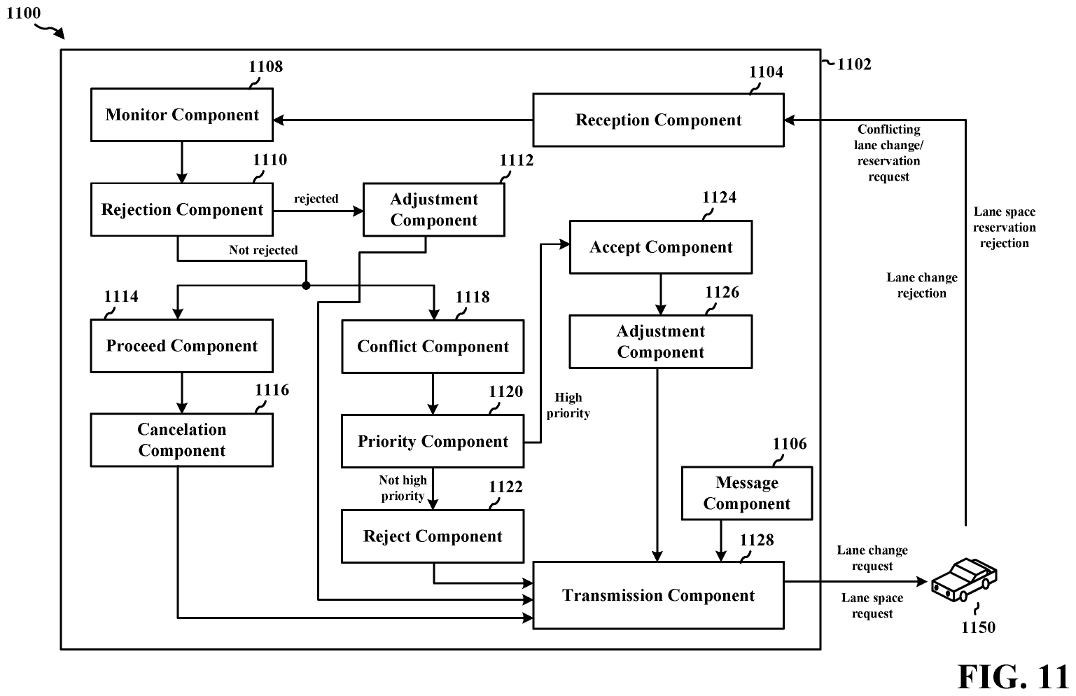

At 1002, the UE may transmit a message comprising at least one of a lane change request or a lane space reservation. For example, 1002 may be performed by message component 1106 from FIG. 11. In some aspects, the lane change request may be transmitted in response to a request from another vehicle. In some aspects, the lane space reservation may be transmitted in response to a request from another vehicle. The UE may transmit the lane space reservation indicating a time for the lane space reservation. The lane space reservation may indicate a reserved space. In some aspects, the reserved space may be indicated based on at least one of geographic coordinates, a timing series of locations representing a trajectory, a location of the UE and a speed of the UE, a relative distance from the UE, an acceleration instruction for a remote vehicle, or a deceleration instruction for the RV. In some aspects, the lane space reservation may indicate at least one of a priority for the lane space reservation or a reason for the lane space reservation. The lane space reservation may indicate a time window for a response to the lane space reservation. In some aspects, the lane space reservation may be transmitted using broadcast or groupcast. The lane space reservation may comprise a unicast transmission directed to a remote vehicle. In some aspects, the lane space reservation may comprise an announce message. In some aspects, the lane space reservation may be transmitted using a beam or a direction associated with a space indicated in the lane space reservation. In some aspects, the UE may transmit a first lane space reservation using a first direction or a first beam and may transmit a second lane space reservation using a second direction or a second beam. In some aspects, the lane change request or the lane space reservation may comprise information associated with a basic safety message.

At 1004, the UE may monitor for a response to the message. For example, 1004 may be performed by monitor component 1108 from FIG. 11. In some aspects, the UE may transmit the lane change request, and may monitor for a response to the message by monitoring for a response to the lane change request from a remote vehicle that accepts or rejects the lane change request.

In some aspects, for example, at 1006, the UE may determine whether a rejection to the lane change request or lane space reservation has been received. For example, 1006 may be performed by rejection component 1110 from FIG. 11. In some aspects, the UE may determine whether a rejection has been received within a time period. In some aspects, when a rejection is received within the time period, the UE, for example at 1008, may adjust or cancel the lane change request or space reservation request. For example, 1008 may be performed by adjustment component 1112 of FIG. 11. In some aspects, the lane space reservation may comprise a request, and the monitoring for a response to the message includes monitoring for a response to the lane space reservation from a remote vehicle that accepts or rejects the lane space reservation.

In some aspects, when a rejection is not received, for example, at 1010, the UE may determine to proceed with a lane change when no response is received that rejects the lane change request within a time period. In yet some aspects, the UE, at 1010, may determine to proceed with a movement when no response is received that rejects the lane space reservation within the time period. For example, 1010 may be performed by proceed component 1114 of FIG. 11. In some aspects, the lane change request may be broadcast by the UE and the response may be received via unicast from the remote vehicle. The lane change request may be unicast by the UE to at least one remote vehicle and the response may be received via unicast from the remote vehicle. The lane change request may indicate at least one of a priority for the lane change request or a reason for the lane change request. In some aspects, the lane change request may indicate a source location prior to a lane change and a destination location following the lane change. The lane change request, in some aspects, may indicate at least one of a start time for a lance change or an end time for the lane change. The lane change request may indicate a target lane space reservation. The lane change request may indicate a movement for the remote vehicle to facilitate a lane change requested by the UE. In some aspects, the lane change request may identify another lane change request message or another space reservation announcement from another UE. The lane change request may indicate a time window for receiving a response to the lane change request.

At 1012, the UE may transmit a cancelation based on a change in condition. For example, 1012 may be performed by cancelation component 1116 of FIG. 11. In some aspects, the UE may transmit the cancelation of the lane change request or the lane space reservation. The cancelation may be transmitted based on a change for at least one of a road condition or a condition that may have triggered the lane change request or the lane space reservation.

In some aspects, when a rejection is not received, for example, at 1014, the UE may receive a conflicting message. For example, 1014 may be performed by conflict component 1118 of FIG. 11. The conflicting message may be a conflicting lane change request or a conflicting lane space reservation. For example, another UE may transmit a lane change request or lane space reservation that may conflict with the request sent by the UE.

In such aspects, the UE, for example at 1016 may determine whether the conflicting message from the other UE has a higher priority than the UE. For example, 1016 may be performed by priority component 1120.

In some aspects, for example at 1018, when the conflicting message does not have a higher priority, the UE may reject the conflicting message. For example, 1018 may be performed by reject component 1122. The UE may transmit a response rejecting the conflicting lane change request or the conflicting lane space reservation when the conflicting lane change request or the conflicting lane space reservation has a lower priority than the lane change request or the lane space reservation transmitted by the UE.

In some aspects, for example at 1020, when the conflicting message does have a higher priority, the UE may transmit a response accepting the conflicting message. For example, 1020 may be performed by accept component 1124 of FIG. 11. The UE may transmit a response accepting the conflicting lane change request or the conflicting lane space reservation when the conflicting lane change request or the conflicting lane space reservation has a higher priority than the lane change request or the lane space reservation transmitted by the UE.

At 1022, the UE may adjust or cancel the lane change request or lane space reservation in response to accepting the conflicting message. For example, 1022 may be performed by adjustment component 1126 of FIG. 11. The UE may cancel or alter its request in order to accommodate the conflicting message having the higher priority.

FIG. 11 is a conceptual data flow diagram 1100 illustrating the data flow between different means/components in an example apparatus 1102. The apparatus may be a UE or a component of a UE (e.g., the UE 104, 310, 902, 906, 1450; the apparatus 1102/1102′; the processing system 1214, which may include memory and which may be an entire UE or a component of a UE). The apparatus includes a reception component 1104 that may be configured to receive various types of signals/messages and/or other information from other devices, including, for example, the UE 1150. The apparatus includes a message component 1106 that may transmit a message comprising at least one of a lane change request or a lane space reservation, e.g., as described in connection with 1002 of FIG. 10. The apparatus includes monitor component 1108 that may monitor for a response to the message, e.g., as described in connection with 1004 of FIG. 10. The apparatus includes a rejection component 1110 that may determine whether a rejection to the lane change request or lane space reservation has been received, e.g., as described in connection with 1006 of FIG. 10. The apparatus includes an adjustment component 1112 that may adjust or cancel the lane change request or space reservation request when a rejection is received within a time period, e.g., as described in connection with 1008 of FIG. 10. The apparatus includes a proceed component 1114 that may determine to proceed with a lane change when no response is received that rejects the lane change request within a time period, e.g., as described in connection with 1010 of FIG. 10. The apparatus includes a cancelation component 1116 that may transmit a cancelation based on a change in condition, e.g., as described in connection with 1012 of FIG. 10. The apparatus includes a conflict component 1118 that may receive a conflicting message, e.g., as described in connection with 1014 of FIG. 10. The apparatus includes a priority component 1120 that may determine whether the conflicting message has a higher priority, e.g., as described in connection with 1016 of FIG. 10. The apparatus includes a rejection component 1122 that may reject the conflicting message when the conflicting message does not have a higher priority, e.g., as described in connection with 1018 of FIG. 10. The apparatus includes an accept component 1124 that may transmit a response accepting the conflicting message when the conflicting message does have a higher priority, e.g., as described in connection with 1022 of FIG. 10. The apparatus includes an adjustment component 1126 that may adjust or cancel the lane change request or lane space reservation in response to accepting the conflicting message, e.g., as described in connection with 1024 of FIG. 10. The apparatus includes a transmission component 1128 that may be configured to transmit various types of signals/messages to the UE 1150.

The apparatus may include additional components that perform each of the blocks of the algorithm in the aforementioned flowcharts of FIG. 10. As such, each block in the aforementioned flowcharts of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

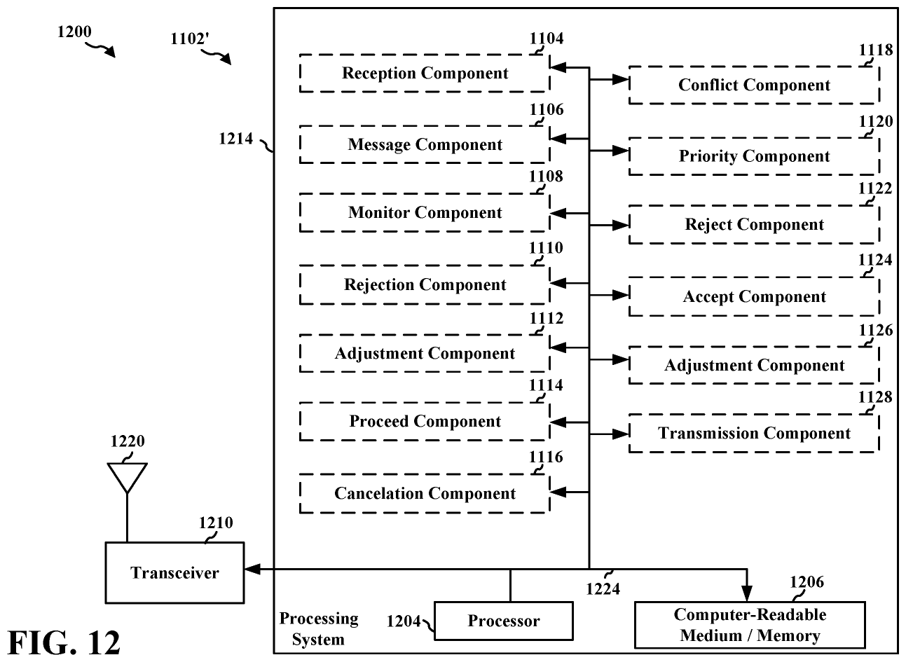

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, 1110, 1112, 1114, 1116, 1118, 1120, 1122, 1124, 1126, 1128, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1128, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1104, 1106, 1108, 1110, 1112, 1114, 1116, 1118, 1120, 1122, 1124, 1126, 1128. The components may be software components running in the processor 1204, resident/stored in the computer readable medium/memory 1206, one or more hardware components coupled to the processor 1204, or some combination thereof. The processing system 1214 may be a component of the first transmitting device 310 or the second transmitting device 350 and may include the memory 376, 360 and/or at least one of the TX processor 316, 368, the RX processor 370, 356, and the controller/processor 375, 359. Alternatively, the processing system 1214 may be the entire UE (e.g., see device 310 or 350 of FIG. 3).

In one configuration, the apparatus 1102/1102′ for wireless communication includes means for transmitting a message comprising at least one of a lane change request or a lane space reservation. The apparatus includes means for monitoring for a response to the message. The apparatus further includes means for determining to proceed with a lane change when no response is received that rejects the lane change request within a time period. The apparatus further includes means for determining to proceed with a movement when no response is received that rejects the lane space reservation within a time period. The apparatus further includes means for transmitting a cancelation of the lane change request or the lane space reservation based on a change for at least one of a road condition or a condition that triggered the lane change request or the lane space reservation. The apparatus further includes means for receiving a conflicting lane change request or a conflicting lane space reservation. The apparatus further includes means for transmitting a response accepting the conflicting lane change request or the conflicting lane space reservation when the conflicting lane change request or the conflicting lane space reservation has a higher priority than the lane change request or the lane space reservation transmitted by the UE. The apparatus further includes means for transmitting a response rejecting the conflicting lane change request or the conflicting lane space reservation when the conflicting lane change request or the conflicting lane space reservation has a lower priority than the lane change request or the lane space reservation transmitted by the UE. The aforementioned means may be one or more of the aforementioned components of the apparatus 1102 and/or the processing system 1214 of the apparatus 1102′ configured to perform the functions recited by the aforementioned means. As described supra, the processing system 1214 may include the TX processor 316, 368, the RX processor 370, 356, and the controller/processor 375, 359. As such, in one configuration, the aforementioned means may be the TX processor 316, 368, the RX processor 370, 356, and the controller/processor 375, 359 configured to perform the functions recited by the aforementioned means.

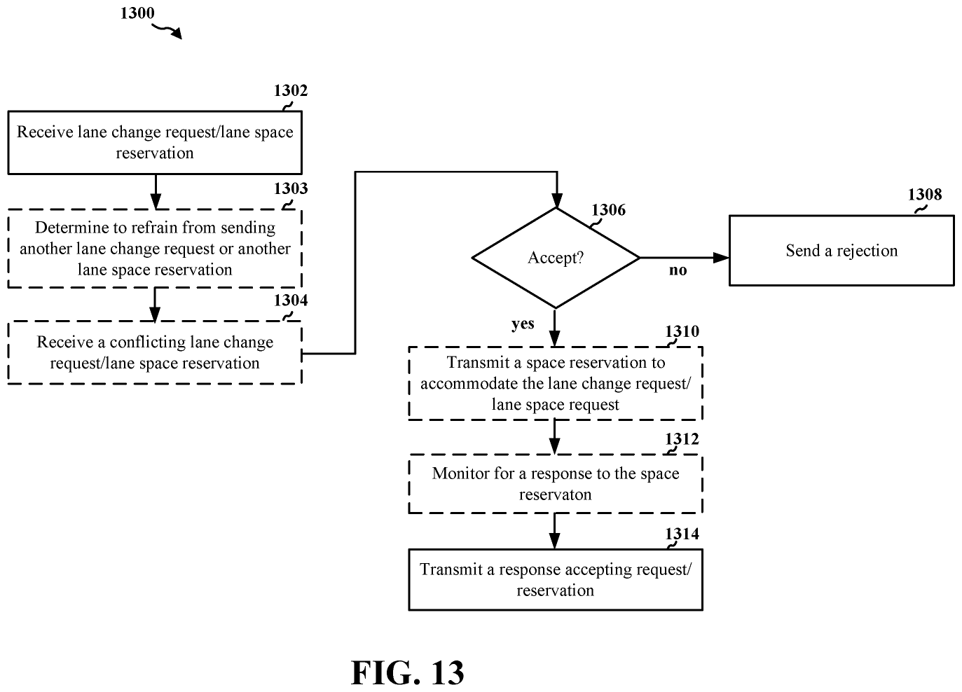

FIG. 13 is a flowchart 1300 of a method of wireless communication. The method may be performed by a UE or a component of a UE (e.g., the UE 104, 350, 904, 1150; the apparatus 1402/1402′; the processing system 1514, which may include memory and which may be an entire UE or a component of a UE). Optional aspects are illustrated with a dashed line. The method may allow a UE to receive messages including a lane change request or a lane space reservation to determine whether to accept or reject the lane change request and/or the lane space reservation, in order to coordinate lane change maneuvers among multiple vehicles in proximity.

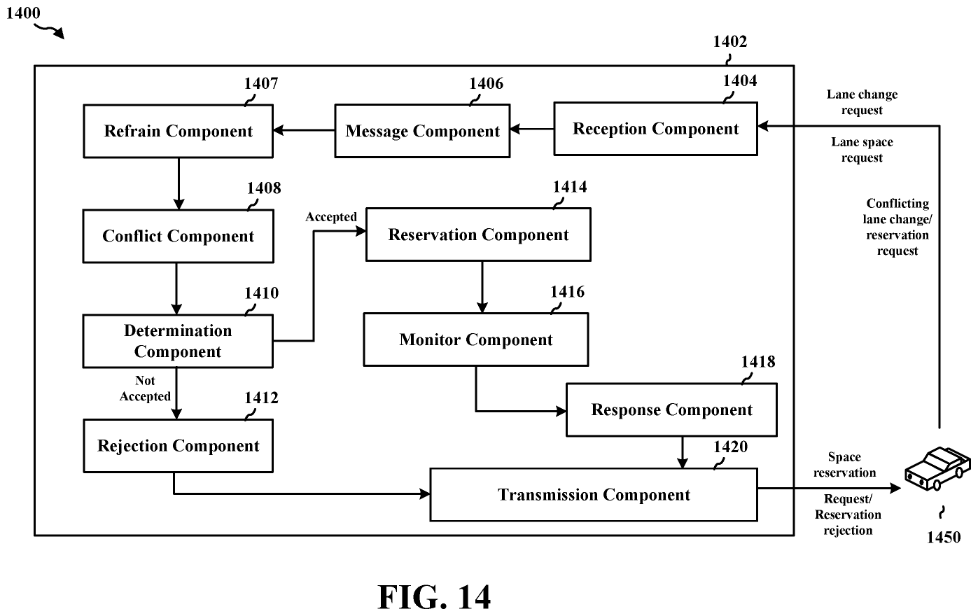

At 1302, the UE associated with a remote vehicle may receive a message comprising at least one of a lane change request or a lane space reservation from a second UE. For example, 1302 may be performed by message component 1406 from FIG. 14. In some aspects, the message may comprise the lane change request indicating at least one of a priority for the lane change request or a reason for the lane change request. The message may comprise the lane change request indicating a source location prior to a lane change and a destination location following the lane change. The message may comprise the lane change request indicating at least one of a start time for a lane change or an end time for the lane change. The message may comprise the lane change request indicating a target lane space reservation. The message may comprise the lane change request indicating a movement for the RV to facilitate a lane change by the UE. In some aspects, the message comprises the lane change request identifying another lane change request message or another space reservation announcement from another UE. The message may comprise the lane space reservation indicating a time for the lane space reservation. The message may comprise the lane space reservation indicting a reserved space. In some aspects, the reserved space may be indicated using at least one of geographic coordinates, a timing series of locations representing a trajectory, a location of the second UE and a speed of the second UE, a relative distance from the second UE, an acceleration instruction for the first UE, or a deceleration instruction for the first UE. In some aspects, the message comprises the lane space reservation indicating at least one of a priority for the lane space reservation or a reason for the lane space reservation. In some aspects, the message comprises the lane space reservation and is received in a broadcast or groupcast from the second UE. The message may comprise the lane space reservation and is comprised in a unicast transmission directed to the first UE. In some aspects, the lane change request or the lane space reservation comprises information associated with a basic safety message.

At 1303, the UE may determine to refrain from sending another lane change request or another lane space reservation. For example, 1303 may be performed by refrain component 1407 from FIG. 14. The UE may determine to refrain from sending another lane change request or another lane space reservation based on receiving the message comprising the at least one of the lane change request or the lane space reservation from the second UE.

At 1304, the UE in some aspects, may receive a conflicting lane change request or a conflicting lane space reservation from a third UE. For example, 1304 may be performed by conflict component 1408 from FIG. 14. In some aspects, the UE determines to accept the lane change request or the lane space reservation when the conflicting lane change request or the conflicting lane space reservation has a lower priority than the lane change request or the lane space reservation. In some aspects, the UE determines to reject the lane change request or the lane space reservation when the conflicting lane change request or the conflicting lane space reservation has a higher priority than the lane change request or the lane space reservation.

At 1306, the UE determines whether to accept the lane change request or the lane space reservation from the second UE. For example, 1306 may be performed by determination component 1410 of FIG. 14. In some aspects, the UE determines whether to accept or reject the lane change request or the lane space reservation.

In some aspects, when the lane change request or the lane space reservation from the second UE is not accepted, for example, at 1308, the UE may transmit a response rejecting the lane change request or the lane space reservation. For example, 1308 may be performed by rejection component 1412 of FIG. 14. In some aspects, the response rejects the lane change request or the lane space reservation, and wherein the response indicates a reason for a rejection of the lane change request or the lane space reservation. The response may include additional information about the rejection of the lane change request or the lane space reservation. The UE, in some aspects, may transmit the response rejecting the lane change request or the lane space reservation when the UE cannot support the lane change request or the lane space reservation.

In some aspects, when the lane change request or the lane space reservation from the second UE is accepted, for example, at 1310, the UE may transmit a space reservation for the first UE. For example, 1310 may be performed by reservation component 1414 of FIG. 14. The UE may transmit the space reservation for the first UE to accommodate the lane change request or the lane space reservation from the second UE. The space reservation may be transmitted using a beam or a direction associated with a space indicated in the space reservation. In some aspects, the UE transmits a first space reservation using a first direction or a first beam and transmits a second space reservation using a second direction or a second beam. The space reservation may comprise an announcement.

In some aspects, the space reservation may comprise a request, such that the UE, for example, at 1312, may monitor for a response to the space reservation. For example, 1312 may be performed by monitor component 1416 of FIG. 14. The UE may monitor for the response to the space reservation prior to transmitting the response to the message from the second UE.

At 1314, the UE may transmit a response to the message accepting the lane change request or the lane space reservation. For example, 1314 may be performed by response component 1418 from FIG. 14. In some aspects, the response accepts the lane change request or the lane space reservation and indicates a maneuver of the UE to accommodate the lane change request or the lane space reservation. In some aspects, the message may be received in a broadcast from the second UE and the response may be transmitted via unicast from the first UE. In some aspects, the message may be received in a unicast from the second UE and the response may be transmitted via unicast from the first UE. The message may comprise the lane change request indicating a time window for the response to the lane change request, and wherein the response is transmitted within the time window. In some aspects, the message may comprise the lane space reservation indicating a time window for the response to the lane space reservation, and wherein the response is transmitted within the time window.

FIG. 14 is a conceptual data flow diagram 1400 illustrating the data flow between different means/components in an example apparatus 1402. The apparatus may be a UE or a component of a UE (e.g., the UE 104, 350, 904, 1150; the apparatus 1402/1402′; the processing system 1514, which may include memory and which may be an entire UE or a component of a UE). The apparatus includes a reception component 1404 that may be configured to receive various types of signals/messages and/or other information from other devices, including, for example, the UE 1450. The apparatus includes a message component 1406 that may receive a message comprising at least one of a lane change request or a lane space reservation from a second UE, e.g., as described in connection with 1302 of FIG. 13. The apparatus includes a refrain component 1407 that may determine to refrain from sending another lane change request or another lane space reservation, e.g., as described in connection with 1303 of FIG. 13. The apparatus includes a conflict component 1408 that may receive a conflicting lane change request or a conflicting lane space reservation from a third UE, e.g., as described in connection with 1304 of FIG. 13. The apparatus includes a determination component 1410 that determines whether to accept the lane change request or the lane space reservation from the second UE, e.g., as described in connection with 1306 of FIG. 13. The apparatus includes a rejection component 1412 that may transmit a response rejecting the lane change request or the lane space reservation when the lane change request or the lane space reservation from the second UE is not accepted, e.g., as described in connection with 1308 of FIG. 13. The apparatus includes a reservation component 1414 that may transmit a space reservation for the first UE when the lane change request or the lane space reservation from the second UE is accepted, e.g., as described in connection with 1310 of FIG. 13. The apparatus includes a monitor component 1416 that may monitor for a response to the space reservation, e.g., as described in connection with 1312 of FIG. 13. The apparatus includes a response component 1418 that may transmit a response to the message accepting the lane change request or the lane space reservation, e.g., as described in connection with 1314 of FIG. 13. The apparatus includes a transmission component 1420 that may be configured to transmit various types of signals/messages to the UE 1450.

The apparatus may include additional components that perform each of the blocks of the algorithm in the aforementioned flowcharts of FIG. 13. As such, each block in the aforementioned flowcharts of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

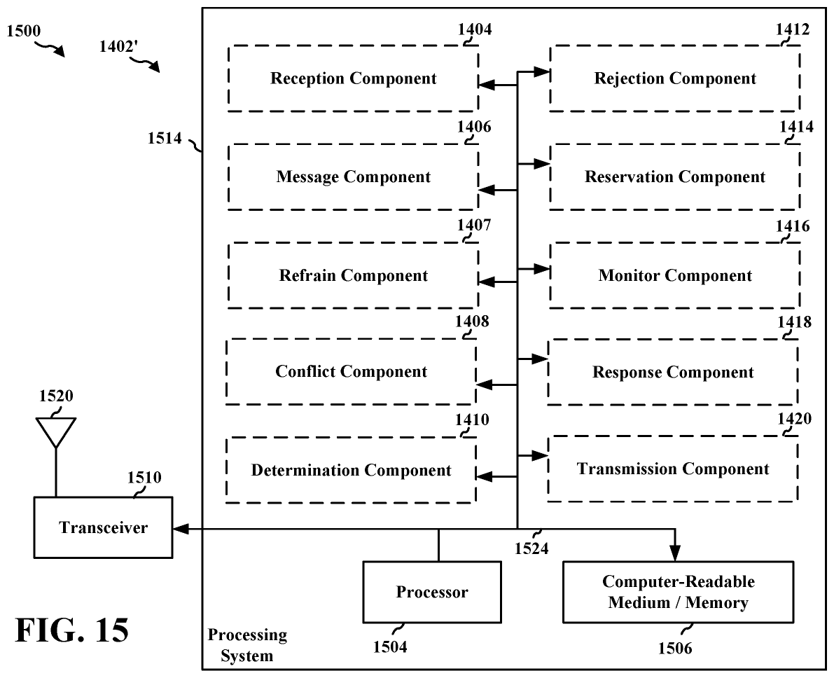

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1407, 1408, 1410, 1412, 1414, 1416 1418, 1420, and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1420, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system 1514 further includes at least one of the components 1404, 1406, 1407, 1408, 1410, 1412, 1414, 1416 1418, 1420. The components may be software components running in the processor 1504, resident/stored in the computer readable medium/memory 1506, one or more hardware components coupled to the processor 1504, or some combination thereof. The processing system 1514 may be a component of the first transmitting device 310 or the second transmitting device 350 and may include the memory 376, 360 and/or at least one of the TX processor 316, 368, the RX processor 370, 356, and the controller/processor 375, 359. Alternatively, the processing system 1514 may be the entire UE (e.g., see device 310 or 350 of FIG. 3).

In one configuration, the apparatus 1402/1402′ for wireless communication includes means for receiving a message comprising at least one of a lane change request or a lane space reservation from a second UE. The apparatus includes means for determining whether to accept the lane change request or the lane space reservation from the second UE. The apparatus includes means for transmitting a response to the message accepting or rejecting the lane change request or the lane space reservation. The apparatus further includes means for receiving a conflicting lane change request or a conflicting lane space reservation from a third UE. The UE determines to accept the lane change request or the lane space reservation when the conflicting lane change request or the conflicting lane space reservation has a lower priority than the lane change request or the lane space reservation. The UE determines to reject the lane change request or the lane space reservation when the conflicting lane change request or the conflicting lane space reservation has a higher priority than the lane change request or the lane space reservation. The apparatus further includes means for transmitting a space reservation for the first UE to accommodate the lane change request or the lane space request from the second UE. The apparatus further includes means for monitoring for a response to the space reservation prior to transmitting the response to the message from the second UE. The apparatus further includes means for determining to refrain from sending another lane change request or another lane space reservation based on receiving the message comprising the at least one of the lane change request or the lane space reservation from the second UE. The aforementioned means may be one or more of the aforementioned components of the apparatus 1402 and/or the processing system 1514 of the apparatus 1402′ configured to perform the functions recited by the aforementioned means. As described supra, the processing system 1514 may include the TX processor 316, 368, the RX processor 370, 356, and the controller/processor 375, 359. As such, in one configuration, the aforementioned means may be the TX processor 316, 368, the RX processor 370, 356, and the controller/processor 375, 359 configured to perform the functions recited by the aforementioned means.

The following examples are illustrative only and may be combined with aspects of other embodiments or teaching described herein, without limitation.

Example 1 is a method of wireless communication at a UE. The method includes transmitting a message comprising at least one of a lane change request or a lane space reservation and monitoring for a response to the message.

In Example 2, the method of Example 1 further includes that the UE transmits the lane change request, and wherein monitoring for a response to the message comprises monitoring for a response to the lane change request from a remote vehicle (RV) that accepts or rejects the lane change request.

In Example 3, the method of Example 1 or Example 2 further includes determining to proceed with a lane change when no response is received that rejects the lane change request within a time period.

In Example 4, the method of any of Examples 1-3 further includes that the lane change request is broadcast by the UE and the response is received via unicast from the RV.

In Example 5, the method of any of Examples 1˜4 further includes that the lane change request is unicast by the UE to at least one RV and the response is received via unicast from the RV.

In Example 6, the method of any of Examples 1-5 further includes that the lane change request indicates at least one of a priority for the lane change request or a reason for the lane change request.

In Example 7, the method of any of Examples 1-6 further includes that the lane change request indicates a source location prior to a lane change and a destination location following the lane change.

In Example 8, the method of any of Examples 1-7 further includes that the lane change request indicates at least one of a start time for a lane change or an end time for the lane change.

In Example 9, the method of any of Examples 1-8 further includes that the lane change request indicates a target lane space reservation.

In Example 10, the method of any of Examples 1-9 further includes that the lane change request indicates a movement for the RV to facilitate a lane change requested by the UE.

In Example 11, the method of any of Examples 1-10 further includes that the lane change request identifies another lane change request message or another space reservation announcement from another UE.

In Example 12, the method of any of Examples 1-11 further includes that the lane change request indicates a time window for receiving a response to the lane change request.

In Example 13, the method of any of Examples 1-12 further includes that the lane change request or the lane space reservation is transmitted in response to a request from another vehicle.

In Example 14, the method of any of Examples 1-13 further includes that the UE transmits the lane space reservation indicating a time period for the lane space reservation.

In Example 15, the method of any of Examples 1-14 further includes that the lane space reservation indicates a reserved space.

In Example 16, the method of any of Examples 1-15 further includes that the reserved spaced is indicated using at least one of: geographic coordinates, a timing series of locations representing a trajectory, a location of the UE and a speed of the UE, a relative distance from the UE, an acceleration instruction for a remote vehicle (RV), or a deceleration instruction for the RV.

In Example 17, the method of any of Examples 1-16 further includes that the lane space reservation indicates at least one of a priority for the lane space reservation or a reason for the lane space reservation.

In Example 18, the method of any of Examples 1-17 further includes that the lane space reservation indicates a time window for a response to the lane space reservation.

In Example 19, the method of any of Examples 1-18 further includes that the lane space reservation is transmitted using broadcast or groupcast.

In Example 20, the method of any of Examples 1-19 further includes that the lane space reservation comprises a unicast transmission directed to a remote vehicle (RV).

In Example 21, the method of any of Examples 1-20 further includes that the lane space reservation comprises an announcement message.

In Example 22, the method of any of Examples 1-21 further includes that the lane space reservation comprises a request, and wherein monitoring for a response to the message comprises monitoring for a response to the lane space reservation from a remote vehicle (RV) that accepts or rejects the lane space reservation.

In Example 23, the method of any of Examples 1-22 further includes t determining to proceed with a movement when no response is received that rejects the lane space reservation within a time period.

In Example 24, the method of any of Examples 1-23 further includes that the lane space reservation is transmitted using a beam or a direction associated with a space indicated in the lane space reservation.

In Example 25, the method of any of Examples 1-24 further includes that the UE transmits a first lane space reservation using a first direction or a first beam and transmits a second lane space reservation using a second direction or a second beam.

In Example 26, the method of any of Examples 1-25 further includes transmitting a cancelation of the lane change request or the lane space reservation based on a change for at least one of a road condition or a condition that triggered the lane change request or the lane space reservation.

In Example 27, the method of any of Examples 1-26 further includes that the lane change request or the lane space reservation comprises information associated with a basic safety message (BSM).

In Example 28, the method of any of Examples 1-27 further includes receiving a conflicting lane change request or a conflicting lane space reservation; transmitting a response accepting the conflicting lane change request or the conflicting lane space reservation when the conflicting lane change request or the conflicting lane space reservation has a higher priority than the lane change request or the lane space reservation transmitted by the UE; and transmitting a response rejecting the conflicting lane change request or the conflicting lane space reservation when the conflicting lane change request or the conflicting lane space reservation has a lower priority than the lane change request or the lane space reservation transmitted by the UE.

Example 29 is a device including one or more processors and one or more memories in electronic communication with the one or more processors storing instructions executable by the one or more processors to cause the system or apparatus to implement a method as in any of Examples 1-28.

Example 30 is a system or apparatus including means for implementing a method or realizing an apparatus as in any of Examples 1-28.

Example 31 is a non-transitory computer readable medium storing instructions executable by one or more processors to cause the one or more processors to implement a method as in any of Examples 1-28.

Example 32 is a method of wireless communication at a first UE associated with a RV. The method includes receiving a message comprising at least one of a lane change request or a lane space reservation from a second UE; determining whether to accept the lane change request or the lane space reservation from the second UE; and transmitting a response to the message accepting or rejecting the lane change request or the lane space reservation.

In Example 33, the method of Example 32 further includes receiving a conflicting lane change request or a conflicting lane space reservation from a third UE, wherein the UE determines to accept the lane change request or the lane space reservation when the conflicting lane change request or the conflicting lane space reservation has a lower priority than the lane change request or the lane space reservation; and wherein the UE determines to reject the lane change request or the lane space reservation when the conflicting lane change request or the conflicting lane space reservation has a higher priority than the lane change request or the lane space reservation.

In Example 34, the method of any of Examples 32-33 further includes that the response rejects the lane change request or the lane space reservation, and wherein the response indicates a reason for a rejection of the lane change request or the lane space reservation.

In Example 35, the method of any of Examples 32-34 further includes that the response includes additional information about the rejection of the lane change request or the lane space reservation.

In Example 36, the method of any of Examples 32-35 further includes that the UE transmits the response rejecting the lane change request or the lane space reservation when the UE cannot support the lane change request or the lane space reservation.

In Example 37, the method of any of Examples 32-36 further includes that the response accepts the lane change request or the lane space reservation and indicates a maneuver of the UE to accommodate the lane change request or the lane space reservation.

In Example 38, the method of any of Examples 32-37 further includes transmitting a space reservation for the first UE to accommodate the lane change request or the lane space request from the second UE.

In Example 39, the method of any of Examples 32-38 further includes that the space reservation comprises a request, the method further comprising: monitoring for a response to the space reservation prior to transmitting the response to the message from the second UE.

In Example 40, the method of any of Examples 32-39 further includes that the space reservation is transmitted using a beam or a direction associated with a space indicated in the space reservation.

In Example 41, the method of any of Examples 32-40 further includes that the UE transmits a first space reservation using a first direction or a first beam and transmits a second space reservation using a second direction or a second beam.

In Example 42, the method of any of Examples 32-41 further includes that the space reservation comprises an announcement.

In Example 43, the method of any of Examples 32-42 further includes that the message is received in a broadcast from the second UE and the response is transmitted via unicast from the first UE.

In Example 44, the method of any of Examples 32-43 further includes that the message is received in a unicast from the second UE and the response is transmitted via unicast from the first UE.

In Example 45, the method of any of Examples 32-44 further includes that the message comprises the lane change request indicating at least one of a priority for the lane change request or a reason for the lane change request.

In Example 46, the method of any of Examples 32-45 further includes that the message comprises the lane change request indicating a source location prior to a lane change and a destination location following the lane change.

In Example 47, the method of any of Examples 32-46 further includes that the message comprises the lane change request indicating at least one of a start time for a lane change or an end time for the lane change.

In Example 48, the method of any of Examples 32-47 further includes that the message comprises the lane change request indicating a target lane space reservation.

In Example 49, the method of any of Examples 32-48 further includes that the message comprises the lane change request indicating a movement for the RV to facilitate a lane change by the UE.

In Example 50, the method of any of Examples 32-49 further includes that the message comprises the lane change request identifying another lane change request message or another space reservation announcement from another UE.

In Example 51, the method of any of Examples 32-50 further includes that the message comprises the lane change request indicating a time window for the response to the lane change request, and wherein the response is transmitted within the time window.

In Example 52, the method of any of Examples 32-51 further includes that the message comprises the lane space reservation indicating a time for the lane space reservation.

In Example 53, the method of any of Examples 32-52 further includes that the message comprises the lane space reservation indicating a reserved space.

In Example 54, the method of any of Examples 32-53 further includes that the reserved spaced is indicated using at least one of: geographic coordinates, a timing series of locations representing a trajectory, a location of the second UE and a speed of the second UE, a relative distance from the second UE, an acceleration instruction for the first UE, or a deceleration instruction for the first UE.

In Example 55, the method of any of Examples 32-54 further includes that the message comprises the lane space reservation indicating at least one of a priority for the lane space reservation or a reason for the lane space reservation.

In Example 56, the method of any of Examples 32-55 further includes that the message comprises the lane space reservation indicating a time window for the response to the lane space reservation, and wherein the response is transmitted within the time window.

In Example 57, the method of any of Examples 32-56 further includes that the message comprises the lane space reservation and is received in a broadcast or groupcast from the second UE.

In Example 58, the method of any of Examples 32-57 further includes that the message comprises the lane space reservation and is comprised in a unicast transmission directed to the first UE.

In Example 59, the method of any of Examples 32-58 further includes that the lane change request or the lane space reservation comprises information associated with a basic safety message (BSM).

In Example 60, the method of any of Examples 32-59 further includes determining to refrain from sending another lane change request or another lane space reservation based on receiving the message comprising the at least one of the lane change request or the lane space reservation from the second UE.

Example 61 is a device including one or more processors and one or more memories in electronic communication with the one or more processors storing instructions executable by the one or more processors to cause the system or apparatus to implement a method as in any of Examples 32-60.

Example 62 is a system or apparatus including means for implementing a method or realizing an apparatus as in any of Examples 32-60.

Example 63 is a non-transitory computer readable medium storing instructions executable by one or more processors to cause the one or more processors to implement a method as in any of Examples 32-60.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
transmitting a message comprising at least one of a lane change request or a lane space reservation; and
monitoring for a response to the message.

2. The method of claim 1, wherein the UE transmits the lane change request, and wherein monitoring for the response to the message comprises:
monitoring for the response to the lane change request from a remote vehicle (RV) that accepts or rejects the lane change request.

3. The method of claim 2, further comprising:
determining to proceed with a lane change when no response is received that rejects the lane change request within a time period.

4. The method of claim 2, wherein the lane change request is broadcast by the UE and the response is received via unicast from the RV.

5. The method of claim 2, wherein the lane change request is unicast by the UE to at least one RV and the response is received via unicast from the RV.

6. The method of claim 2, wherein the lane change request indicates at least one of:
a priority for the lane change request,
a reason for the lane change request,
a source location prior to a lane change and a destination location following the lane change,
a start time for the lane change,
an end time for the lane change,
a target lane space reservation,
a movement for the RV to facilitate the lane change requested by the UE,
an identification of another lane change request message or another space reservation announcement from another UE, or
a time window for receiving the response to the lane change request.

7.-12. (canceled)

13. The method of claim 1, wherein the lane change request or the lane space reservation is transmitted in response to a request from another vehicle.

14. (canceled)

15. (canceled)

16. The method of claim 1, wherein the lane space reservation indicates a reserved spaced using at least one of:
geographic coordinates,
a timing series of locations representing a trajectory,
a location of the UE and a speed of the UE,
a relative distance from the UE,
an acceleration instruction for a remote vehicle (RV), or
a deceleration instruction for the RV.

17. The method of claim 1, wherein the lane space reservation indicates at least one of:
a priority for the lane space reservation,
a reason for the lane space reservation,
a time period for the lane space reservation, or
a time window for the response to the lane space reservation.

18.-20. (canceled)

21. The method of claim 1, wherein the lane space reservation comprises an announcement message.

22. The method of claim 1, wherein the lane space reservation comprises a request, and wherein monitoring for the response to the message comprises monitoring for the response to the lane space reservation from a remote vehicle (RV) that accepts or rejects the lane space reservation, the method further comprising:
determining to proceed with a movement when no response is received that rejects the lane space reservation within a time period.

23. (canceled)

24. The method of claim 1, wherein the lane space reservation is transmitted using a beam or a direction associated with a space indicated in the lane space reservation, and wherein the UE transmits a first lane space reservation using a first direction or a first beam and transmits a second lane space reservation using a second direction or a second beam.

25. (canceled)

26. The method of claim 1, further comprising:
transmitting a cancelation of the lane change request or the lane space reservation based on a change for at least one of a road condition or a condition that triggered the lane change request or the lane space reservation.

27. The method of claim 1, wherein the lane change request or the lane space reservation comprises information associated with a basic safety message (BSM).

28. The method of claim 1, further comprising:
receiving a conflicting lane change request or a conflicting lane space reservation;
transmitting a first response accepting the conflicting lane change request or the conflicting lane space reservation when the conflicting lane change request or the conflicting lane space reservation has a higher priority than the lane change request or the lane space reservation transmitted by the UE; and
transmitting a second response rejecting the conflicting lane change request or the conflicting lane space reservation when the conflicting lane change request or the conflicting lane space reservation has a lower priority than the lane change request or the lane space reservation transmitted by the UE.

29. (canceled)

30. (canceled)

31. An apparatus for wireless communication at a user equipment (UE), comprising:
a memory; and
at least one processor coupled to the memory and configured to:
transmit a message comprising at least one of a lane change request or a lane space reservation; and
monitor for a response to the message.

32. (canceled)

33. A method of wireless communication at a first user equipment (UE) associated with a remote vehicle (RV), comprising:
receiving a message comprising at least one of a lane change request or a lane space reservation from a second UE;
determining whether to accept the lane change request or the lane space reservation from the second UE; and
transmitting a response to the message accepting or rejecting the lane change request or the lane space reservation.

34. The method of claim 33, further comprising:
receiving a conflicting lane change request or a conflicting lane space reservation from a third UE,
wherein the UE determines to accept the lane change request or the lane space reservation when the conflicting lane change request or the conflicting lane space reservation has a lower priority than the lane change request or the lane space reservation; and
wherein the UE determines to reject the lane change request or the lane space reservation when the conflicting lane change request or the conflicting lane space reservation has a higher priority than the lane change request or the lane space reservation.

35. The method of claim 33, wherein the response rejects the lane change request or the lane space reservation, and wherein the response indicates a reason for a rejection of the lane change request or the lane space reservation, and wherein the response includes additional information about the rejection of the lane change request or the lane space reservation.

36. (canceled)

37. The method of claim 33, wherein the UE transmits the response rejecting the lane change request or the lane space reservation when the UE cannot support the lane change request or the lane space reservation.

38. The method of claim 33, wherein the response accepts the lane change request or the lane space reservation and indicates a maneuver of the UE to accommodate the lane change request or the lane space reservation.

39. The method of claim 33, further comprising:
transmitting a space reservation for the first UE to accommodate the lane change request or the lane space request from the second UE; and
monitoring for a response to the space reservation prior to transmitting the response to the message from the second UE.

40. (canceled)

41. The method of claim 39, wherein the space reservation is transmitted using a beam or a direction associated with a space indicated in the space reservation, and wherein the UE transmits a first space reservation using a first direction or a first beam and transmits a second space reservation using a second direction or a second beam.

42. (canceled)

43. The method of claim 39, wherein the space reservation comprises an announcement.

44. (canceled)

45. (canceled)

46. The method of claim 33, wherein the message indicated at least one of:
a priority for the lane change request,
a reason for the lane change request,
a source location prior to a lane change and a destination location following the lane change,
a start time for the lane change,
an end time for the lane change,
a target lane space reservation,
a movement for the RV to facilitate the lane change requested by the UE,
an identification of another lane change request message or another space reservation announcement from another UE, or
a time window for receiving the response to the lane change request.

47.-52. (canceled)

53. The method of claim 33, wherein the message comprises the lane space reservation indicating at least one of:
a time for the lane space reservation,
a reserved space,
a priority for the lane space reservation,
a reason for the lane space reservation, or
a time window for the response to the lane space reservation.

54. (canceled)

55. The method of claim 53, wherein the reserved spaced is indicated using at least one of:
geographic coordinates,
a timing series of locations representing a trajectory,
a location of the second UE and a speed of the second UE,
a relative distance from the second UE,
an acceleration instruction for the first UE, or
a deceleration instruction for the first UE.

56.-59. (canceled)

60. The method of claim 33, wherein the lane change request or the lane space reservation comprises information associated with a basic safety message (BSM).

61. The method of claim 33, further comprising:
determining to refrain from sending another lane change request or another lane space reservation based on receiving the message comprising the at least one of the lane change request or the lane space reservation from the second UE.

62. (canceled)

63. (canceled)

64. An apparatus for wireless communication at a first user equipment (UE) associated with a remote vehicle (RV), comprising:
a memory; and
at least one processor coupled to the memory and configured to:
receive a message comprising at least one of a lane change request or a lane space reservation from a second UE;
determine whether to accept the lane change request or the lane space reservation from the second UE; and
transmit a response to the message accepting or rejecting the lane change request or the lane space reservation.

65. (canceled)
